(19) United States
(12) Patent Application Publication
(10) Pub. No.: US 2022/0343743 A1
(43) Pub. Date: Oct. 27, 2022

(54) DISPLAY CONTROL APPARATUS, DISPLAY CONTROL METHOD, AND PROGRAM

(71) Applicant: NEC Corporation, Minato-ku, Tokyo (JP)

(72) Inventors: Jun UCHIMURA, Tokyo (JP); Yuji TAHARA, Tokyo (JP); Rina TOMITA, Tokyo (JP); Yasuyo KAZO, Tokyo (JP)

(73) Assignee: NEC Corporation, Minato-ku, Tokyo (JP)

(21) Appl. No.: 17/634,016

(22) PCT Filed: Aug. 19, 2020
(86) PCT No.: PCT/JP2020/031207

§ 371 Date: Feb. 9, 2022

(30) Foreign Application Priority Data
Aug. 22, 2019 (JP) 2019-151771

(51) Int. Cl. G08B 13/196; H04N 7/18; G06Q 30/02; G06F 3/0484

(52) U.S. Cl. CPC G08B 13/19691; H04N 7/18; G06Q 30/0251; G06F 3/0484; G06F 2203/04803

(57) ABSTRACT

A display control apparatus (100) includes a display processing unit (102) that displays, when a predetermined condition is satisfied, an image of a surveillance camera (5) of a store on at least one display (10) installed in the store.

### TECHNICAL FIELD

The present invention relates to a display control apparatus, a display control method, a program, and a display control system, and more specifically relates to a display control apparatus, a display control method, a program, and a display control system that control a display in a store.

### BACKGROUND ART

Patent Document 1 describes a digital signage system that displays a map indicating locations of a plurality of stores on a digital signage, and displays, when a position of a store on the map is touched with a finger, a video of a surveillance camera disposed in a vicinity, on a ceiling of an aisle, and the like of the store on the digital signage.

### RELATED DOCUMENT

### Patent Document

[Patent Document 1] Japanese Patent Application Publication No. 2018-10613

### SUMMARY OF THE INVENTION

### Technical Problem

In recent years in which shortage of manpower is a social problem, it has been studied that a store is operated in an unmanned state where there is no store clerk or by remotely managing a plurality of stores due to manpower reduction even in a manned store. In this case, a possibility in that a customer exhibits a suspicious behavior in a store increases.

In view of the circumstance, the present invention has been made, and an object of the present invention is to provide a technique for preventing a suspicious behavior in a store during unmanned business operation or during manpower reduction operation based on remote management of a plurality of stores.

### Solution to Problem

Each of aspects of the present invention employs a constitution described below in order to solve the above-described problem.

A first aspect relates to a display control apparatus.

The display control apparatus according to the first aspect includes

a display processing unit that displays, when a predetermined condition is satisfied, an image of a surveillance camera of a store on at least one display installed in the store.

A second aspect relates to a display control method executed by at least one computer.

The display control method according to the second aspect includes,

by a display control apparatus,

displaying, when a predetermined condition is satisfied, an image of a surveillance camera of a store on at least one display installed in the store.

Note that, another aspect according to the present invention may be a program causing at least one computer to execute the method according to the second aspect described above or may be a computer-readable storage medium that stores such a program. The storage medium includes a non-transitory tangible medium.

The computer program includes a computer program code that causes, when executed by a computer, the computer to execute the display control method on a display control apparatus.

Note that, any combination of the above components and an expression achieved by converting an expression according to the present invention among a method, an apparatus, a system, a storage medium, a computer program, and the like are also effective as an aspect according to the present invention.

Further, various types of components according to the present invention do not necessarily need to exist independently of each other; and a plurality of components may be formed as one member, one component may be formed with a plurality of members, a certain component may be a part of another component, a part of a certain component and a part of another component may be overlapped, and others may be included.

Further, according to the method and the computer program of the present invention, a plurality of steps are described in order, but an order of the description does not limit an order for executing a plurality of steps. Therefore, when the method and the computer program according to the present invention are executed, an order of the plurality of steps can be modified without posing an obstacle in content

Moreover, a plurality of steps of the method and the computer program according to the present invention are not limited to execution at timings different from each other. Therefore, a way in such that during execution of a certain step, another step occurs, a way in such that an execution timing of a certain step and a part or all of execution timings of other steps are overlapped, and the like are made possible.

### Advantageous Effects of Invention

According to each of the aspects described above, a technique for preventing a suspicious behavior in a store during unmanned business operation or during manpower reduction operation based on remote management of a plurality of stores can be provided.

### BRIEF DESCRIPTION OF THE DRAWINGS

FIG. 1 is a schematic diagram illustrating a scene in a store.

FIG. 2 is a function block diagram illustrating a logical configuration example of a display control apparatus according to an example embodiment of a present invention.

FIG. 3 is a diagram illustrating one example of a POS screen of a POS terminal.

FIG. 4 is a block diagram illustrating a hardware configuration of a computer that achieves the display control apparatus illustrated in FIG. 2.

FIG. 5 is a flowchart illustrating one example of an operation of the display control apparatus according to the example embodiment.

FIG. 6 is a function block diagram illustrating a logical configuration example of the display control apparatus according to the example embodiment.

FIG. 7 is a flowchart illustrating one example of an operation of the display control apparatus according to the example embodiment.

FIG. 8 is a flowchart illustrating another example of an operation of the display control apparatus according to the example embodiment.

FIG. 9 is a flowchart illustrating one example of an operation of the display control apparatus according to the example embodiment.

FIG. 10 is a diagram illustrating an example of a screen displayed by a display processing unit.

FIG. 11 is a function block diagram illustrating a logical configuration example of the display control apparatus according to the example embodiment.

FIG. 12 is a diagram illustrating a display example of an advertisement image and a crime prevention video on a divided screen.

FIG. 13 is a diagram illustrating another display example of an advertisement image and a crime prevention video on a divided screen.

FIG. 14 is a flowchart illustrating one example of an operation of the display control apparatus according to the example embodiment.

FIG. 15 is a flowchart illustrating another example of an operation of the display control apparatus according to the example embodiment.

FIG. 16 is a function block diagram illustrating a logical configuration example of the display control apparatus according to the example embodiment.

FIG. 17 is a flowchart illustrating one example of an operation of the display control apparatus according to the example embodiment.

FIG. 18 is a diagram illustrating transition of a screen of the display control apparatus according to the example embodiment.

FIG. 19 is a diagram for illustrating an example in which an image of a surveillance camera is displayed on a four-divided screen.

FIG. 20 is a diagram for illustrating another example in which an image of a surveillance camera is displayed on a four-divided screen

### DESCRIPTION OF EMBODIMENTS

Hereinafter, an example embodiment according to the present invention is described by using the accompanying drawings. Note that, in all drawings, a similar component is assigned with a similar reference sign and description is omitted, as appropriate. Further, in the following figures, a configuration of a portion being not related to an essence according to the present invention is omitted and therefore is not illustrated.

### First Example Embodiment

### System Outline

A display control system according to the example embodiment of the present invention displays, when an unmanned business operation or a manpower reduction operation based on remote management of a plurality of stores is conducted in a store such as a convenience store, a video of a surveillance camera (not illustrated) on a display such as a signage in a store. This is aimed at an effect of preventing a suspicious behavior and the like by causing a store visitor to recognize being monitored. According to each example embodiment described below, a store may conduct a business operation in an unmanned manner in an entire business time or may conduct a business operation in an unmanned manner in a part of a business time. Further, a pattern in which a plurality of stores are operated based on remote management may be applicable due to manpower reduction, and in this case, in a plurality of stores, stores based on a manned business operation and an unmanned business operation may be mixed.

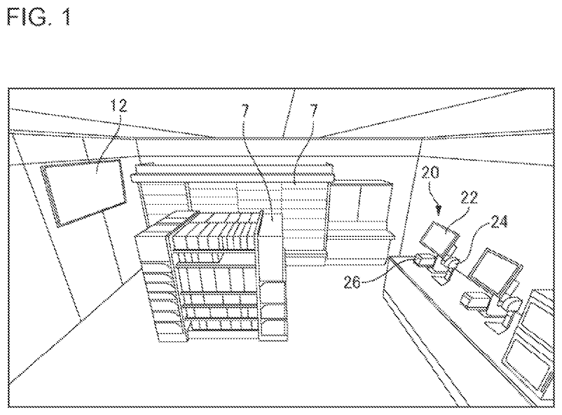

FIG. 1 is a schematic diagram illustrating a scene in a store. In the store, a plurality of product shelves 7 including a showcase and the like are disposed. Further, in the store, a surveillance camera (not illustrated in FIG. 1) that image-captures a scene in the store is disposed. The surveillance camera is preferably, for example, a camera capable of capturing an image in a 360-degree omni-direction disposed on a ceiling of the store in order to prevent a crime. As one example, the surveillance camera is a camera mounted with a fish-eye lens.

Further, in the store, a display such as a signage 12 is installed. On the signage 12, for example, an image of an advertisement content and a content including notification information such as a precaution item to a customer and a message is displayed. The image is at least either of a still image or a moving image.

Further, in the store, a POS terminal 20 with which a customer can execute product registration processing and settlement processing is disposed, and thereby a store without dependence on a store clerk is achievable. The POS terminal 20 includes a touch panel-type display 22, a scanner 24 that reads a bar code, and a printer 26 that printing-outputs a receipt and the like.

A customer operates a touch panel and thereby can execute product registration processing and settlement processing. A customer, for example, causes an own smartphone (not illustrated) to display a bar code indicating a previously-member-registered member ID and causes the scanner 24 to read the bar code, acquire the member ID, and identify the customer, and thereafter causes the scanner 24 to further read a product bar code, whereby the customer executes registration processing of a product to purchase.

Settlement processing may be executed, for example, based on a payment method previously specified by an identified customer. For example, card payment, electronic money payment, and the like may be specified. In a case of card payment, a customer can previously register a card number. Further, at a time of settlement processing, input of identification confirmation information (e.g., a password, a PIN code, a birth date, and the like) for identification authentication is requested by the display 22 from a customer, as necessary, and thereby the input may be executed.

### Function Configuration Example

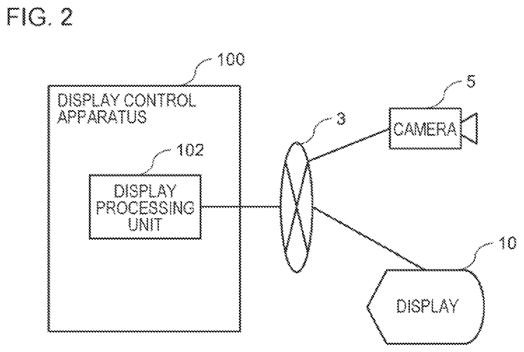

FIG. 2 is a function block diagram illustrating a logical configuration example of a display control apparatus 100 according to the example embodiment of the present invention. The display control apparatus 100 includes a display processing unit 102. The display processing unit 102 displays, when a previously-determined condition is satisfied, an image of a surveillance camera 5 of a store on at least one display 10 installed in the store.

According to the present example embodiment, the display 10 display-controlled by the display processing unit 102 is, for example, at least either of the signage 12 or the display 22 of the POS terminal 20 illustrated in FIG. 1. The display 10 is, for example, a liquid crystal display, a plasma display, an organic electro-luminescence (EL) display, a projector, or the like.

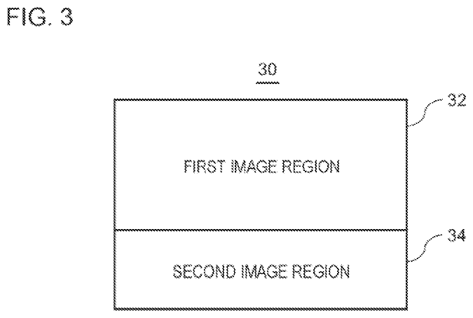

FIG. 3 is a diagram illustrating one example of a POS screen 30 of the POS terminal 20. The POS screen 30 of the POS terminal 20 may include a first screen region 32 in order for a customer to execute an operation of product registration processing or integration processing, and a second screen region 34 that displays, for example, an advertisement image or notification information to a customer other than an operation screen related to product registration processing or integration processing. The display processing unit 102 may display, for example, an image of the surveillance camera 5 in the second screen region 34 of the display 22.

The display control apparatus 100 is connected to the surveillance camera 5 and the display 10 via a communication network 3. Note that, in each figure, a communication device such as a relay necessary for connecting each apparatus to the communication network 3 is not illustrated. An image generated by the surveillance camera 5 is transmitted to the display control apparatus 100 via the communication network 3. Alternatively, the display control apparatus 100 may request an image from the surveillance camera 5 via the communication network 3 and acquire the requested image.

According to the example embodiment, “acquisition” includes at least either of a matter that an own apparatus fetches data or information stored in another apparatus or a storage medium (active acquisition) and a matter that data or information output from another apparatus to an own apparatus is input (passive acquisition). An example of active acquisition includes a matter that a request or an inquiry is made to another apparatus and a response thereto is received, a matter that another apparatus or a storage medium is accessed and reading is executed, and the like. Further, an example of passive acquisition includes a matter that information distributed (or transmitted, reported on a push basis, or the like) is received, and the like. Further, “acquisition” may include a matter that data or information is selectively acquired from among received pieces of data or information or a matter that distributed data or information is selectively received.

An image transmitted to the display control apparatus 100 is a video captured by the surveillance camera 5 in real time. However, an image transmitted to the display control apparatus 100 may not necessarily be transmitted directly from the surveillance camera 5 and may be an image stored in a storage medium which is not illustrated. Further, an image transmitted to the display control apparatus 100 may be an image delayed by a predetermined time.

A previously-determined condition for displaying an image of the surveillance camera 5 includes a case in which a signal for setting an operation pattern of a relevant store as a determined mode is input.

A store may have a business operation pattern including, for example, at least a manned mode in which a store clerk is present in a store and an unmanned mode in which a store clerk is absent. Further, a business operation pattern of a store may include a one-person operation mode in which only one store clerk copes. Setting of a mode of a business operation pattern in a store can be executed by a store clerk based on an operation of an operation screen, an operation switch, or the like of a store system (not illustrated) in cooperation with the display control apparatus 100 according to the present example embodiment.

Further, a previously-determined condition may include, other than a case in which a signal or information for setting a determined mode is input, a case in which a signal or information indicating that a switch to a determined mode is made is input, and a case where a signal or information indicating a current operation pattern in a store is acquired and the signal or the information indicates a determined mode.

Further, a previously-determined condition may include a case in which a predetermined time comes.

For example, a time at which a store is unmanned is previously specified, and when the time comes, an image of the surveillance camera 5 may be displayed.

A condition for displaying an image of the surveillance camera 5 may be a combination of a plurality of conditions different from each other or may be specified by a conditional expression including a logical expression. A condition is stored in a storage apparatus, to be described later, of the display control apparatus 100. A condition may be modified by accepting setting executed by an operator based on an operation screen of the display control apparatus 100.

### Hardware Configuration Example

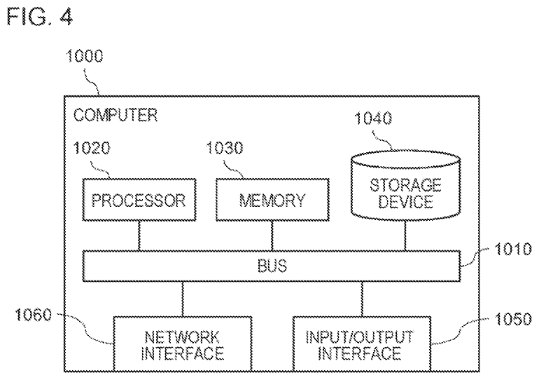

FIG. 4 is a block diagram illustrating a hardware configuration of a computer 1000 that achieves the display control apparatus 100 illustrated in FIG. 2. The computer 1000 includes a bus 1010, a processor 1020, a memory 1030, a storage device 1040, an input/output interface 1050, and a network interface 1060.

The bus 1010 is a data transmission path in which the processor 1020, the memory 1030, the storage device 1040, the input/output interface 1050, and the network interface 1060 mutually transmit/receive data. However, a method of connecting the processor 1020 and the like to each other is not limited to bus connection.

The processor 1020 is a processor achieved by a central processing unit (CPU), a graphics processing unit (GPU), or the like.

The memory 1030 is a main storage apparatus achieved by a random access memory (RAM) or the like.

The storage device 1040 is an auxiliary storage apparatus achieved by a hard disk drive (HDD), a solid state drive (SSD), a memory card, a read only memory (ROM), or the like. The storage device 1040 stores a program module that achieves each function of the computer 1000. The processor 1020 reads each of the program modules onto the memory 1030 and executes the read program module, and thereby each function relevant to the program module is achieved.

A program module may be stored in a storage medium. A storage medium that stores a program module includes a non-transitory tangible medium usable by the computer 1000, and a program code readable by the computer 1000 (processor 1020) may be imbedded in the medium.

The input/output interface 1050 is an interface for connecting the computer 1000 to various types of input/output devices.

The network interface 1060 is an interface for connecting the computer 1000 to the communication network 3. The communication network 3 is, for example, a local area network (LAN) and a wide area network (WAN). A method of connecting to the communication network 3 based on the network interface 1060 may be wireless connection or wired connection.

Then, the computer 1000 is connected to a required device (e.g., the surveillance camera 5 and the display 10) via the input/output interface 1050 or the network interface 1060.

### Operation Example

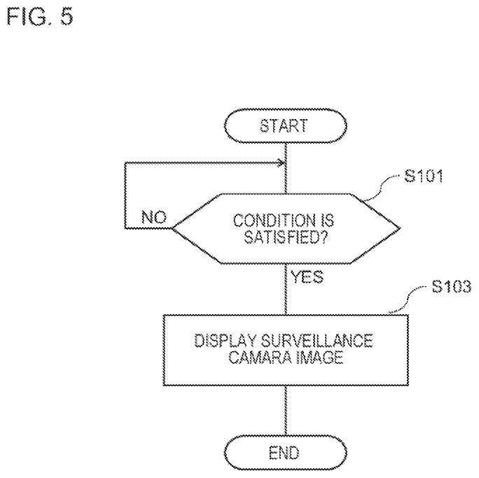

FIG. 5 is a flowchart illustrating one example of an operation of the display control apparatus 100 according to the present example embodiment. The display processing unit 102 displays, when a previously-determined condition is satisfied (YES in step S101), an image of the surveillance camera 5 of a store on at least one display 10 installed in the store (S103).

The display processing unit 102 displays, when, for example, accepting input of a signal in which a store is in an unmanned mode or in a one-person operation mode (YES in step S101), an image of the surveillance camera 5 in at least either of the signage 12 and a partial region (e.g., the second screen region 34 in FIG. 3) of the display 22 of the POS terminal 20 (step S103).

Alternatively, when a predetermined time (e.g., 23:00) at which a store becomes in an unmanned mode comes (YES in step S101), the display processing unit 102 displays an image of the surveillance camera 5 in at least either of the signage 12 and a partial region (e.g., the second screen region 34 in FIG. 3) of the display 22 of the POS terminal 20 (step S103).

As described above, according to the display control apparatus 100 of the present example embodiment, the display processing unit 102 displays, when a previously-determined condition is satisfied, an image of the surveillance camera 5 on the display 10, and therefore, even in a state where, for example, monitoring in a store is inadequate, such as in an unmanned mode or a one-person operation mode, an image of the surveillance camera 5 is displayed on the display 10 in the store and a store visitor is caused to recognize being monitored, whereby a crime prevention effect of dissuading the store visitor from an action of a crime or the like is exhibited. Further, also a fact that an image of the surveillance camera 5 is viewed by another customer is made conscious, and thereby a crime prevention effect of dissuading from an action of a crime or the like can be expected.

### Second Example Embodiment

### Function Configuration Example

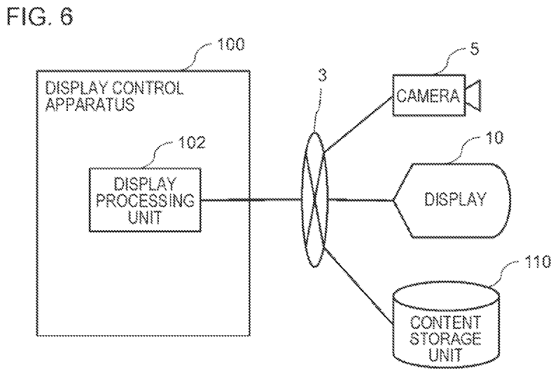

FIG. 6 is a function block diagram illustrating one example of a logical configuration of a display control apparatus 100 according to the present example embodiment. The display control apparatus 100 according to the present example embodiment is the same as that of the example embodiment described above except that display is switched from an advertisement image to an image of a surveillance camera 5.

In the display control apparatus 100 according to the present example embodiment, a display processing unit 102 is connected to a content storage unit 110. The content storage unit 110 stores a content such as an advertisement image. The content storage unit 110 may be a storage apparatus outside the display control apparatus 100 or may be included in a storage device 1040.

Content data stored in the content storage unit 110 are an advertisement image of a product and a service which can be purchased in a store. The content may include information for encouraging a customer to repeatedly visit a store or information for arousing purchase motivation. Alternatively, an image including information for notifying a customer of a guide of a store, a precaution item, and the like may be included.

The display processing unit 102 displays, when a previously-determined condition is satisfied, an image of the surveillance camera 5 by switching from an advertisement image.

Further, the display processing unit 102 may alternately display an advertisement image and an image of the surveillance camera 5.

### Operation Example

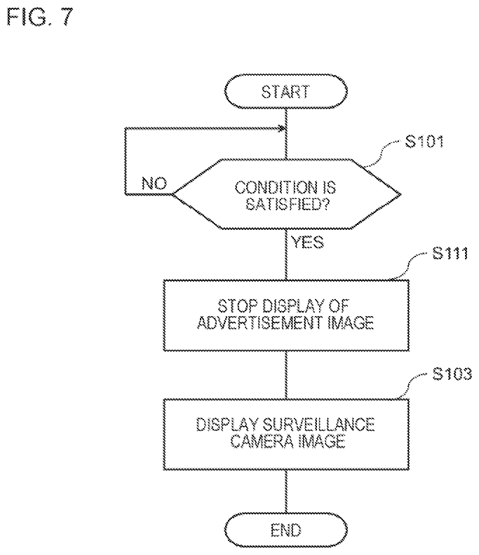

FIG. 7 is a flowchart illustrating one example of an operation of the display control apparatus 100 according to the present example embodiment.

A flow according to the present example embodiment further includes step S111, in addition to the flow according to the example embodiment described above in FIG. 5. The display processing unit 102 stops, when a previously-determined condition is satisfied (YES in step S101), display of an advertisement image on the display 10 (step S111). Then, in step S103, the display processing unit 102 displays an image of the surveillance camera 5 on the display 10.

The display processing unit 102 stops, when, for example, accepting input of a signal in which a store is in an unmanned mode or in a one-person operation mode (YES in step S101), an advertisement image being displayed in at least either of a signage 12 and a partial region (e.g., a second screen region 34 in FIG. 3) of a display 22 of a POS terminal 20 (step S111). Then, an image of the surveillance camera 5 is displayed in at least either of the signage 12 and a partial region (e.g., the second screen region 34 in FIG. 3) of the display 22 of the POS terminal 20 (step S103).

Alternatively, when a predetermined time (e.g., 23:00) comes (YES in step S101), the display processing unit 102 stops an advertisement image being displayed in at least either of the signage 12 and a partial region (e.g., the second screen region 34 in FIG. 3) of the display 22 of the POS terminal 20 (step S111). Then, an image of the surveillance camera 5 is displayed in at least either of the signage 12 and a partial region (e.g., the second screen region 34 in FIG. 3) of the display 22 of the POS terminal 20 (step S103).

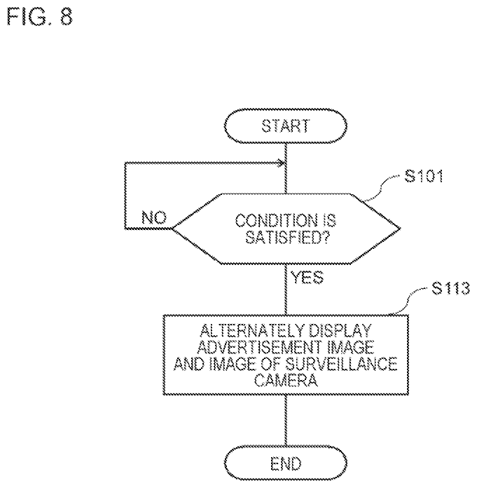

Further, as illustrated in FIG. 8 as another example, the display processing unit 102 alternately displays, when a previously-determined condition is satisfied (YES in step S101), an advertisement image and an image of the surveillance camera 5 on at least one display 10 installed in a store (S113).

The display processing unit 102 alternately displays, when, for example, accepting input of a signal in which a store is in an unmanned mode or in a one-person operation mode (YES in step S101), an advertisement image and an image of the surveillance camera 5 in at least either of the signage 12 and a partial region (e.g., the second screen region 34 in FIG. 3) of the display 22 of the POS terminal 20 (step S113).

Alternatively, when a predetermined time (e.g., 23:00) comes (YES in step S101), the display processing unit 102 alternately displays an advertisement image and an image of the surveillance camera 5 in at least either of the signage 12 and a partial region (e.g., the second screen region 34 in FIG. 3) of the display 22 of the POS terminal 20 (step S113).

According to the present example embodiment, when a previously-determined condition is satisfied, for example, at a time of a determined mode such as an unmanned store mode and the like or when a predetermined time comes, the display processing unit 102 can stop display of an advertisement image and display an image of the surveillance camera 5 on the display 10. In other words, at a time without a determined mode or when a predetermined time is not reached, an advertisement image and the like are displayed on the display 10, and thereby an advertisement effect can be increased, and at a time of a determined mode or at a predetermined time, an image of the surveillance camera 5 exhibiting a high crime prevention effect can be displayed on the display 10 by efficiently switching from an advertisement image.

Further, when a previously-determined condition is satisfied, an advertisement image and an image of the surveillance camera 5 are alternately displayed on the display 10, and thereby even after a previously-determined condition is satisfied, a crime prevention effect based on an image of the surveillance camera 5 is also exhibited while an advertisement effect based on an advertisement image is maintained.

### Third Example Embodiment

### Function Configuration Example

A display control apparatus 100 according to the present example embodiment is the same as that of the example embodiment described above except that an advertisement image and an image of a surveillance camera 5 are displayed together on divided screens. The display control apparatus 100 according to the present example embodiment includes the same configuration as the display control apparatus 100 in FIG. 6 according to the example embodiment described above.

A display processing unit 102 may screen-divide and display simultaneously an advertisement image and an image of a surveillance camera 5.

### Operation Example

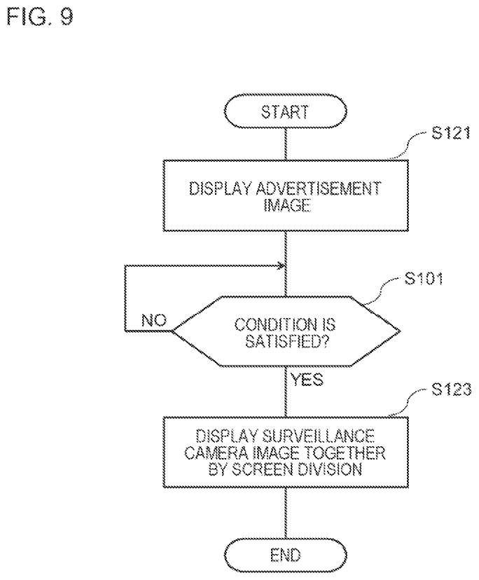

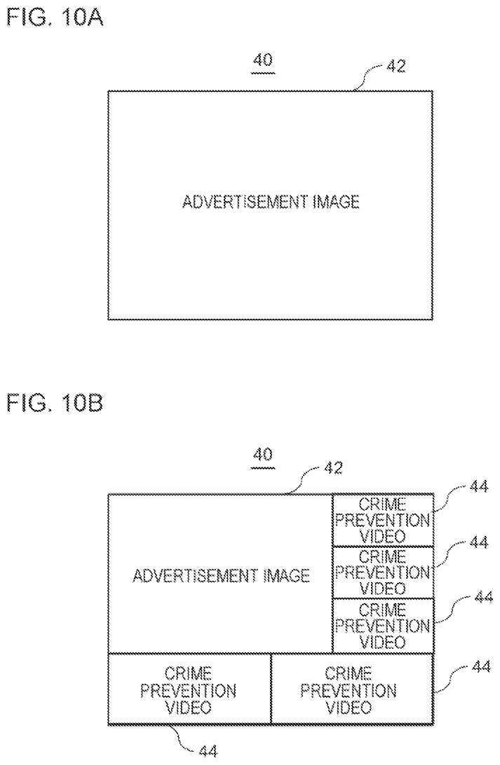

FIG. 9 is a flowchart illustrating one example of an operation of the display control apparatus 100 according to the present example embodiment. FIG. 10 is a diagram illustrating an example of a screen 40 displayed by the display processing unit 102.

First, the display processing unit 102 displays an advertisement image 42 (FIG. 10A) on the screen 40 of a display 10 (step S121). Then, the display processing unit 102 screen-divides, when a previously-determined condition is satisfied (YES in step S101), and displays together an advertisement image 42 and a crime prevention video 44 of the surveillance camera 5 on the screen 40 (FIG. 10B) of the display 10 (step S123).

For example, as in FIG. 10A, it is assumed that first, the advertisement image 42 is displayed on the screen 40 of a signage 12. Then, the display processing unit 102 divides, when, for example, accepting input of a signal in which a store is in an unmanned mode or in a one-person operation mode (YES in step S101), the screen 40 of the signage 12 into six parts, as illustrated in FIG. 10B, and displays simultaneously one advertisement image 42 and five images (in the figure, illustrated as the crime prevention video 44) of the surveillance camera 5.

In the advertisement image 42, it is difficult to modify an aspect ratio of a screen, and therefore the image is displayed by being reduced with a fixed aspect ratio. Then, each crime prevention video 44 is displayed by modifying an aspect ratio. Images of a plurality of crime prevention videos 44 may be the same image or may be images acquired by capturing images in different places in a store. Alternatively, even in the same place, an image acquired by zooming in or zooming out a determined place is employable or an image acquired by gradually shifting an image-capture time or an image-capture direction is employable.

As described above, according to the present example embodiment, when a previously-determined condition is satisfied, the display processing unit 102 divides, for example, at a time of a determined mode such as an unmanned mode and the like or when a predetermined time comes, the screen 40 having only the advertisement image 42 and thereby can display together the advertisement image 42 and the crime prevention video 44. Thereby, both an advertisement effect based on the advertisement image 42 and a crime prevention effect based on an image of the surveillance camera 5 can be acquired.

### Fourth Example Embodiment

### Function Configuration Example

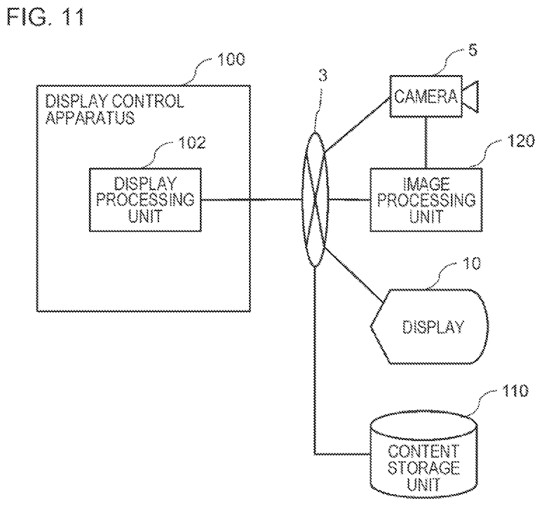

FIG. 11 is a function block diagram illustrating a logical configuration example of a display control apparatus 100 according to the present example embodiment. The display control apparatus 100 according to the present example embodiment is different from that of the example embodiment described above in that, according to a result of image recognition processing, display of a display 10 is requested.

According to the present example embodiment, a display processing unit 102 inputs a signal from an image processing unit 120 that executes image processing for an image of a surveillance camera 5. The image processing unit 120 may be included in the display control apparatus 100 or may be an external apparatus. The image processing unit 120 may be included, for example, in a surveillance system that remotely monitors a store.

According to the present example embodiment, a previously-determined condition includes a case in which an image processing result of a customer satisfies a criterion. The image processing unit 120 executes image processing for an image of a customer that is image-captured by the surveillance camera 5. For example, image recognition processing is executed for an object held by a customer, and a fact that the object is matched with a feature value of a weapon such as a gun and a knife at a level of a threshold or more is included in a condition.

Alternatively, a fact that a feature value of a person registered in at least either of a blacklist or a whitelist is matched at a level of a threshold or more may be included in a condition. Herein, the blacklist stores, for example, a feature value of a marked person to be monitored, for example, such as a person who committed shoplifting in the past. The whitelist stores, for example, a feature value of a person not to be monitored, for example, such as a regular customer and a store clerk. A feature value of a person includes at least any one of a face, an iris, a fingerprint, an auricle, a body type, a gait, and clothes. The display processing unit 102 may switch, when a feature value registered on a blacklist is matched, to an image of the surveillance camera 5, and may not switch, when a feature value registered on a whitelist is matched, to an image of the surveillance camera 5.

In this case, in order to notify a customer other than the customer of existence of this suspicious person, the display processing unit 102 may preferentially display, on a display 10 being able to be viewed by the customer other the suspicious person, an image of the surveillance camera 5, i.e., a video of the suspicious person. When, for example, the suspicious person enters a store, an image of the surveillance camera 5 is displayed on a display 22 of a POS terminal 20 in a case where another customer is operating the POS terminal 20. In this manner. the display processing unit 102 may select a display 10 for display according to an authentication result by the image processing unit 120.

Further, the image processing unit 120 may execute a behavior analysis of a customer. Then, a fact that a behavior of a customer is matched at a level of a threshold or more with a behavior seeming to be shoplifting of a product may be included in a condition.

The display processing unit 102 may display, when a behavior of a customer seeming to be shoplifting of a product is detected by image recognition processing, an image for recommending a product related to the product. The image processing unit 120 determines, based on image recognition processing, a product seeming to be shoplifted by a customer, determines an image for recommending purchasing a product previously associated with the determined product, and displays the determined image on the display 10. The image processing unit 120 displays, when, for example, determining that a customer shoplifts a boxed lunch, an image for recommending purchasing tea on the display 10.

Further, the display processing unit 102 displays an advertisement image and an image of the surveillance camera 5 with a ratio of both of the images changed according to a result of image recognition processing for a customer. A ratio to be modified is at least any one of a display time, a size of an image region, and the number of screens.

When, for example, a store visitor is a person registered on a blacklist, a ratio for displaying an image of the surveillance camera 5 is increased. When a store visitor is a person registered on a whitelist, a ratio for displaying an advertisement image is increased. On the whitelist, a member-registered customer, a regular customer, and the like may be registered according to a rank indicating confidence. For a regular customer having higher confidence, a higher rank is set. When, as a result of image recognition processing, a rank of a customer is high, the display processing unit 102 increases a ratio of display of an advertisement image, or may continue displaying an advertisement image without switching to an image of the surveillance camera 5.

In a case of a member-registered customer, the customer may be stored by previously associating member identification information with confidence of the customer. Then, for example, at a time of entering a store, on a smartphone (not illustrated) of a customer, a bar code of member identification information is displayed and read by holding the smartphone over a bar code reader (not illustrated), and thereby the display processing unit 102 may acquire, from the member identification information read by the barcode reader in the store, information of confidence of the customer.

Similarly to the display processing unit 102 according to the example embodiment described above, also according to the present example embodiment, when an image processing result of a customer satisfies a criterion, a screen 40 is divided and thereby an advertisement image 42 and an image of a crime prevention video 44 may be displayed together. Then, the display processing unit 102 may display an advertisement image and an image of the surveillance camera 5 with a ratio of both of the images changed according to a result of image recognition processing of the customer.

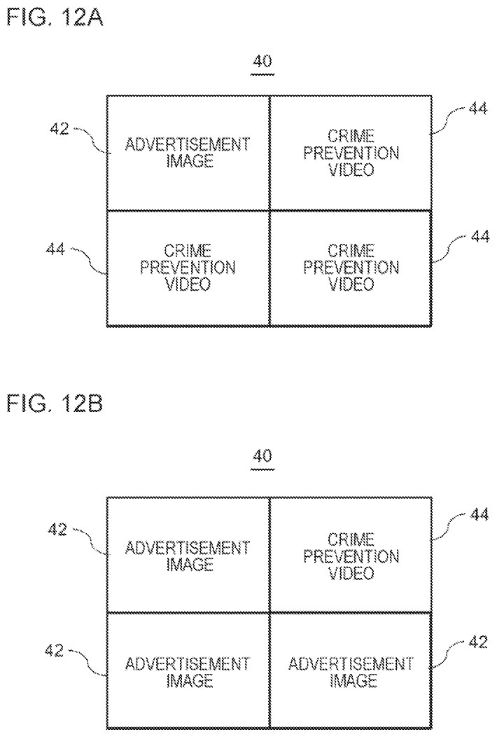

In this case, when, for example, a store visitor is recognized from an image as a person registered on a blacklist, the display processing unit 102 divides, as illustrated in FIG. 12A, the screen 40 into four parts, displays the advertisement image 42 on one screen, displays the crime prevention video 44 on three screens, and thereby increases a ratio of an image of the surveillance camera 5. On the other hand, when a store visitor is recognized from an image as a person registered on a whitelist, the display processing unit 102 divides, as illustrated in FIG. 12B, the screen 40 into four parts, displays the advertisement image 42 on three screens, displays the crime prevention video 44 on one screen, and thereby increases a ratio of the advertisement image 42. Further, in another example, the advertisement image 42 and the crime prevention video 44 may be displayed on two screens each. Positions where the advertisement image 42 and the crime prevention video 44 are displayed may be modified according to time.

Further, a condition for displaying an image (crime prevention video 44) of the surveillance camera 5 may include a case in which input by at least either of a store clerk and a remote surveillant is accepted. When, for example, a person thought to be suspicious by a store clerk or a remote surveillant is present, the display processing unit 102 receives a signal in which a terminal, an operation switch, or the like is operated.

Further, a condition for displaying an image (crime prevention video 44) of the surveillance camera 5 may include a case in which an alarm is received. The alarm is detected and output by at least any one of a remote surveillance system (not illustrated), a sensor (not illustrated), a notification system (not illustrated), and an image recognition processing system. The alarm is a signal indicating that an alarm is occurred, and may include information of any of a type of an alarm, an occurrence time, and an occurrence position (for example, identification information of a surveillance camera, an image-capture range, and the like are employable).

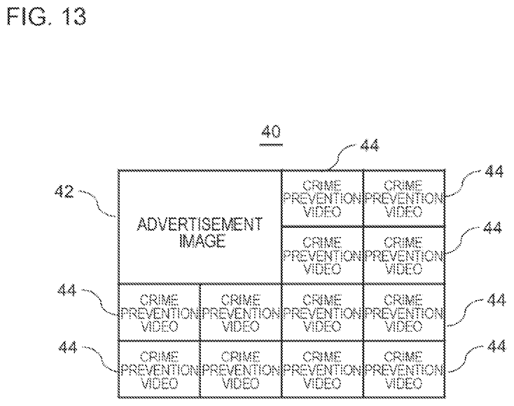

The display processing unit 102 may enlarge and display, by zooming-in, the crime prevention video 44 acquired by image-capturing a place where an alarm is detected. Further, every time an alarm is received, a screen is divided into fine parts, and thereby the crime prevention video 44 of a place where an alarm is occurred may be displayed. For example, after division into four screens as in FIG. 12A, the crime prevention video 44 is displayed on three screens, and thereafter, when an alarm is further received, as in FIG. 13, each screen is further divided into four parts, and on each screen of twelve screens, the crime prevention video 44 may be displayed.

The display processing unit 102 may return, when not receiving an alarm after an elapse of a fixed time, screen division to an original state. Screen division may be collectively returned to an original state or may be returned in a stepwise manner in response to an elapsed time in such a way that, for example, the crime prevention video 44 is returned from twelve screens to three screens and the crime prevention video 44 is returned from the three screens to no display of the crime prevention video 44.

### Operation Example

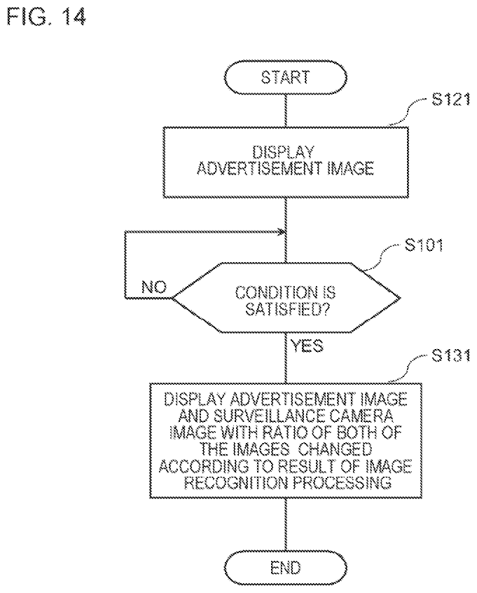

FIG. 14 is a flowchart illustrating one example of an operation of the display control apparatus 100 according to the present example embodiment.

First, the display processing unit 102 displays an advertisement image 42 (FIG. 10) on the display 10 (step S121). Then, when a previously-determined condition is satisfied (YES in step S101), for example. when a result of image recognition processing for a customer satisfies a criterion, the display processing unit 102 displays, on the display 10 the advertisement image 42 and an image (crime prevention video 44) of the surveillance camera 5 with a ratio of both of the images changed according to a result of image recognition processing for the customer (step S131).

As described above, as a result of image recognition processing for a customer, when confidence of the customer is high, the advertisement image 42 is allocated to three screens and the crime prevention video 44 is allocated to one screen, whereby a ratio of the advertisement image 42 is increased as in FIG. 12B. On the other hand, as a result of image recognition processing for a customer, when confidence of the customer is low, the crime prevention video 44 is allocated to three screens and the advertisement image 42 is allocated to one screen, whereby a ratio of the crime prevention video 44 is increased as in FIG. 12A.

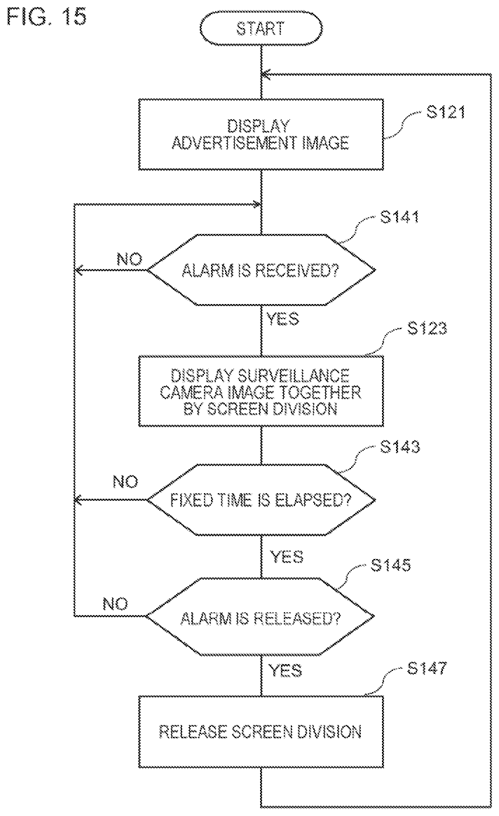

FIG. 15 is a flowchart illustrating another example of an operation of the display control apparatus 100 according to the present example embodiment. First, the display processing unit 102 displays the advertisement image 42 (FIG. 10) on the display 10 (step S121). Then, the display processing unit 102 screen-divides, when receiving an alarm (YES in step S141), and displays an image (crime prevention video 44) of the surveillance camera 5 together with the advertisement image 42 (step S143). The display processing unit 102 divides, for example, the screen 40 into four parts as in FIG. 12A, displays the advertisement image 42 on one screen, and displays the crime prevention video 44 on three screens. At that time, the crime prevention video 44 of a place related to the received alarm is preferentially displayed. Alternatively, the crime prevention video 44 of a place related to the received alarm may be enlarged and displayed by zooming in.

Then, after a fixed time is elapsed from start of display of the crime prevention video 44 (YES in step S143) and also when the alarm has been released (YES in step S145), screen division is released (step S147) and processing returns to the step S121.

On the other hand, before a fixed time is elapsed (NO in step S143) or when the alarm has not been released (NO in step S145), processing returns to the step S141. Then, when a new alarm is further received (YES in the step S141), each screen on which the crime prevention video 44 is being displayed as in FIG. 12B is further divided into four parts and the crime prevention video 44 is displayed on each screen (step S123). Also in this case, the crime prevention video 44 of a place related to the received alarm is preferentially displayed.

As described above, according to the present example embodiment, according to a result of image recognition processing, a ratio of the advertisement image 42 and the crime prevention video 44 is modified and these images are displayed on the display 10, and therefore when, for example, a store visitor is recognized from an image as a person registered on a blacklist, display can be performed by increasing a ratio of the crime prevention video 44, and therefore a crime prevention effect can be further exhibited. On the other hand, when a store visitor is recognized from an image as a person registered on a whitelist, display can be performed by increasing a ratio of the advertisement image 42, and therefore an advertisement effect can be further exhibited.

Further, according to the present example embodiment, every time an alarm is received, the screen 40 is finely divided and the crime prevention video 44 of a place related to the alarm can be preferentially displayed, and therefore crime prevention power can be expected more effectively.

### Fifth Example Embodiment

### Function Configuration Example

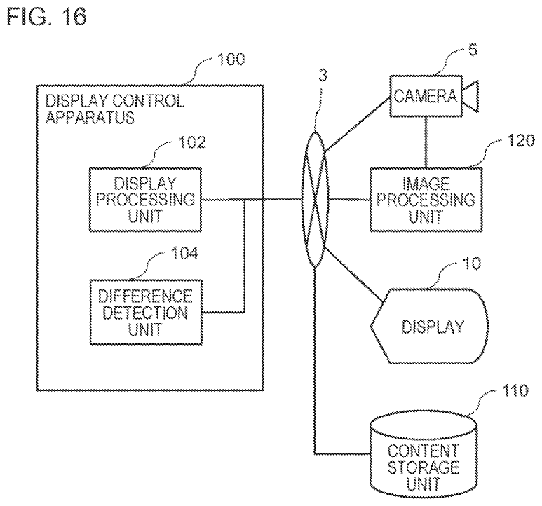

FIG. 16 is a function block diagram illustrating a logical configuration example of a display control apparatus 100 according to the present example embodiment. The display control apparatus 100 according to the present example embodiment is the same as that of the example embodiment described above expect that a configuration for using a difference detection function of a surveillance camera 5 is included.

In the display control apparatus 100 according to the present example embodiment, a condition for displaying the surveillance camera 5 includes a case in which a signal (hereinafter, referred to as a difference detection signal) indicating that a difference among a plurality of images generated at timings different from each other by a difference detection function of the surveillance camera 5 is detected is received. A difference detection unit 104 receives a difference detection signal.

A case where a difference detection signal is received includes, for example, a case in which a person enters a store, a case in which a person moves in a store, and the like.

Further, a display processing unit 102 may receive a difference detection signal from each of a plurality of surveillance cameras 5. The display processing unit 102 displays an image of the surveillance camera 5 that transmits a difference detection signal.

A difference detection signal is transmitted from the surveillance camera 5 associated with, for example, at least either of identification information of the surveillance camera 5 that transmits a difference detection signal and information (e.g., identification information and a frame number of an image, an image-capture time, and the like) capable of identifying an image in which a difference is detected. Based on the information, the display processing unit 102 can determine the surveillance camera 5 that outputs a difference detection signal or an image.

Herein, after a difference detection signal is received and a crime prevention video 44 is displayed by the difference detection unit 104, the display processing unit 102 continues providing a video of the same surveillance camera 5 for a fixed time. This can prevent a phenomenon in which a switch of the crime prevention video 44 frequently occur when the crime prevention video 44 is switched every time a difference is detected. Alternatively, the display processing unit 102 may display, when a difference detection signal is received and thereafter a difference detection signal transmitted from another surveillance camera 5 does not exist, the crime prevention videos 44 of a plurality of surveillance cameras 5 by sequentially switching these videos.

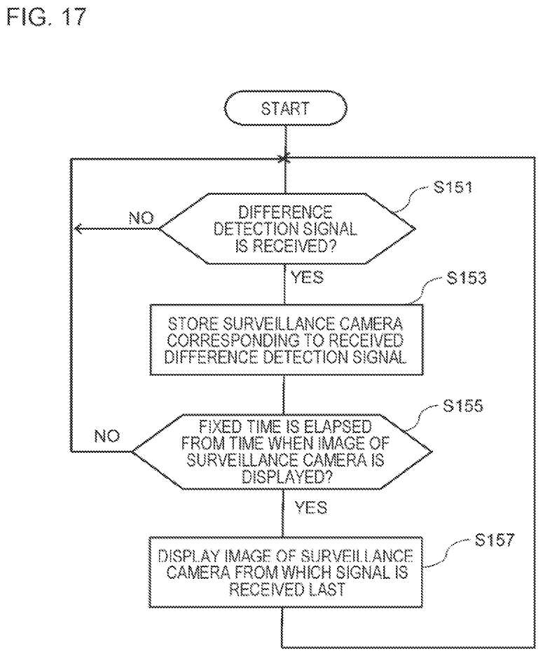

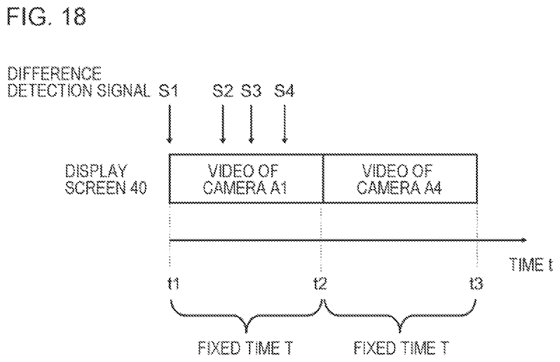

Hereinafter, a case is specifically described in which, by using a plurality of surveillance cameras 5, difference detection processing is executed. FIG. 17 is a flowchart illustrating one example of an operation of the display control apparatus 100 according to the present example embodiment. FIG. 18 is a diagram illustrating transition of a screen of the display control apparatus 100 according to the present example embodiment. Herein, it is assumed that, from four surveillance cameras 5 (herein, referred to as cameras A1, A2, A3, and A4), difference detection signals S1, S2, S3, and S4 are received, respectively.

The display processing unit 102 stores, when receiving the first difference detection signal S1 from the camera A1 at a time of t1 (YES in step S151), a fact that the surveillance camera 5 of the received difference detection signal S1 is the camera A1 (step S153). Then, when a fixed time T is elapsed from display of the crime prevention video 44 of the surveillance camera 5 (YES in step S155) or when a difference detection signal is received for a first time, the display processing unit 102 displays, on a display 10, the crime prevention video 44 (FIG. 18) of the camera A1 having transmitted the difference detection signal S1 (step S157).

Thereafter, in the step S151, also from the cameras A2, A3, and A4, the difference detection signals S2, S3, and S4 are sequentially received (FIG. 18). However, a fixed time T is not elapsed (NO in step S155) and therefore processing returns to the step S151, and the display processing unit 102 continues displaying the crime prevention video 44 of the camera A1 having first transmitted the difference detection signal S1. Then, the display processing unit 102 sequentially stores the cameras that transmit the difference detection signals. Then, after an elapse of the fixed time T (YES in the step S155) with respect to the crime prevention video 44 of the camera A1, the display processing unit 102 displays, on the display 10, the crime prevention video 44 of the camera A4 that transmits the difference detection signal S4 last within the fixed time T (the step S157). Then, until the fixed time T is elapsed, display of the crime prevention video 44 of the camera A4 is continued (FIG. 18).

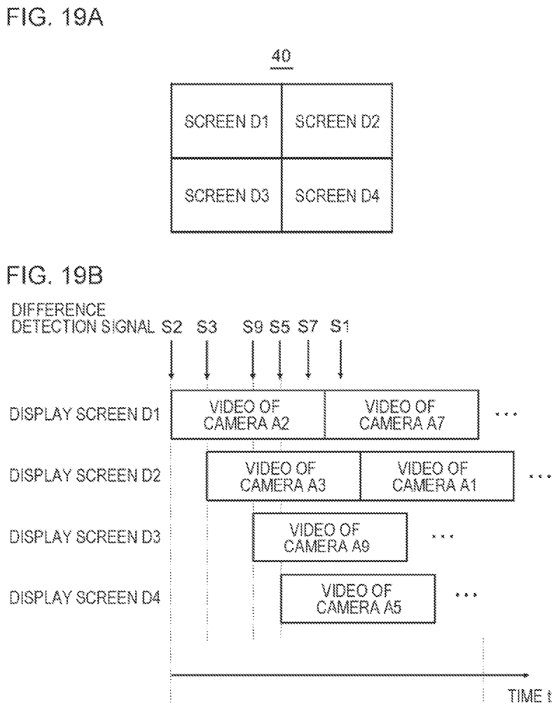

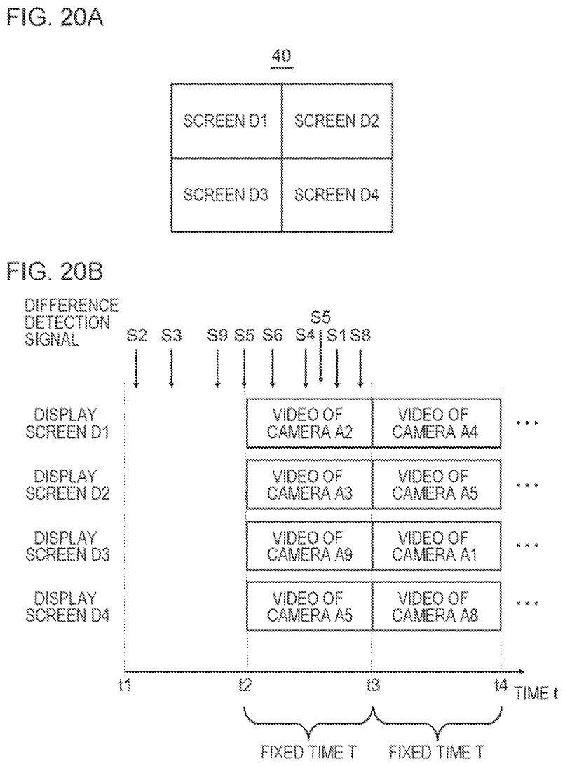

FIG. 19 and FIG. 20 each are a diagram for illustrating an example in which the crime prevention video 44 of the surveillance camera 5 that transmits a difference detection signal is sequentially displayed on a four-divided screen 40. Herein, an example in which an advertisement image 42 is not displayed and the crime prevention video 44 is displayed on all of four divided screens D1, D2, D3, and D4 is described.

In an example in FIG. 19, the display processing unit 102 displays, for a fixed time T each, the crime prevention videos 44 of the surveillance cameras 5 that each transmits a difference detection signal on each screen (herein, four screens D1, D2, D3, and D4) in order of reception of the difference detection signal. Then, with respect each screen, when the fixed time T is elapsed, the crime prevention video 44 of the surveillance camera 5 that transmits a difference detection signal received last is further displayed for a fixed time T each.

In an example in FIG. 20, the display processing unit 102 sequentially displays, for a fixed time T, an image of the surveillance camera 5 that transmits a difference detection signal on each screen (herein, four screens D1, D2, D3, and D4). Then, after the fixed time T is elapsed, the display processing unit 102 sequentially displays an image of the surveillance camera 5 that transmits a latest difference detection signal. The display processing unit 102 displays, for example, the crime prevention videos 44 of surveillance cameras A2, A3, A9, and A5 of difference detection signals S2, S3, S9, and S5 received from times t1 to t2 on display screens D1, D2, D3, and D4, respectively. Then, when a time t3 comes after an elapse of a fixed time T, the display processing unit 102 displays, for a fixed time T until a time t4, the crime prevention videos 44 of surveillance cameras A4, A5, A1, and A8 of difference detection signals S4, S5, S1, and S8 received at a last minute on the display screens D1, D2, D3, and D4, respectively.

As described above, according to the present example embodiment, the display processing unit 102 displays, when receiving a difference detection signal from the surveillance camera 5, an image of the surveillance camera 5 having transmitted the signal on the display 10, and therefore can display, on the display 10, the crime prevention video 44 of a person who enters a store and a person who is moving in the store. Further, the display processing unit 102 sequentially displays, based on a difference detection signal received from each of a plurality of surveillance cameras 5, the crime prevention video 44 of the surveillance camera 5 that transmits the signal on a divided screen, and therefore can display, on the diplay 10, the crime prevention video 44 that tracks a person who is moving in a store.

While example embodiments of the present invention have been described with reference to the drawings, these example embodiments are only exemplification of the present invention, and various configurations other than the above-described configurations can also be employed.

The display processing unit 102 may perform display so that, for example, among a plurality of images acquired by image-capturing a plurality of product shelves by using a plurality of surveillance cameras 5, a ratio of an image of a shelf likely to be subjected to shoplifting is increased. Herein, a shelf likely to be subjected to shoplifting is at least any one of a shelf on which an expensive product is placed, a shelf which is in a blind area, and a shelf specified by a store clerk.

Further, the display processing unit 102 may display, when displaying an image of the surveillance camera 5 on the display 10, a character, a mark, an icon, or the like reporting at least either of a fact that the crime prevention video 44 is being displayed and a fact that an inside of a store is being monitored by the surveillance camera 5 on the crime prevention video 44 in a superposition manner.

Further, the display 10 may be, for example, a display of a shelf tag of a product shelf 7 other than a signage 12 or a display 22 of a POS terminal 20. The display processing unit 102 may preferentially display an image of the surveillance camera 5 on a display of a shelf tag of the shelf likely to be subjected to shoplifting.

Moreover, the display processing unit 102 may display the crime prevention video 44 on the display 10 of a mobile terminal of a customer. A customer previously registers member information, and installs and then activates an application for providing a service of the system. An application used by a customer in a mobile terminal may include, for example, a function for providing a coupon to a customer using a store and displaying an advertisement. By using the application, the display control apparatus 100 acquires location information of a customer or identifies a mobile terminal of a customer by causing the mobile terminal to display, by a bar code, member identification information of the customer and causing the customer to hold the mobile terminal over a bar code reader (not illustrated) at a time of entering a store. Then, the display processing unit 102 displays the crime prevention video 44 on the identified mobile terminal.

The example embodiments and modified aspects described above can be combined without a contradiction with each other.

While the present application of the invention has been described with reference to example embodiments and examples, the present application of the invention is not limited to the example embodiments and the examples. The constitution and details according to the present application of the invention can be subjected to various modifications which can be understood by those of ordinary skill in the art without departing from the scope of the invention of the present application.

Note that, according to the present invention, information relating to a user such as a customer and the like should be legally acquired and used.

The whole or part of the example embodiments disclosed above can be described as, but not limited to, the following supplementary notes.

1. A display control apparatus including

a display processing unit that displays, when a predetermined condition is satisfied, an image of a surveillance camera of a store on at least one display installed in the store.

2. The display control apparatus according to supplementary note 1, wherein

the at least one display further includes a display of a POS terminal.

3. The display control apparatus according to supplementary note 1 or 2, wherein

the predetermined condition includes a case in which a signal for setting an operation pattern of the store as a determined mode is input.

4. The display control apparatus according to any one of supplementary notes 1 to 3, wherein

the predetermined condition includes a case in which a predetermined time comes.

5. The display control apparatus according to any one of supplementary notes 1 to 4, wherein

the predetermined condition includes a case in which an image processing result of a customer satisfies a criterion.

6. The display control apparatus according to any one of supplementary notes 1 to 5, wherein

the display processing unit displays an advertisement image and the image of the surveillance camera with a ratio of both of the images changed according to a result of image recognition processing for a customer.

7. The display control apparatus according to any one of supplementary notes 1 to 6, wherein

the predetermined condition includes a case in which input by at least either of a store clerk and a remote surveillant is accepted.

8. The display control apparatus according to any one of supplementary notes 1 to 7, wherein

the predetermined condition includes a case in which an alarm is received.

9. The display control apparatus according to any one of supplementary notes 1 to 8, wherein

the predetermined condition includes a case in which a signal indicating that a difference among a plurality of images respectively generated at different timings by the surveillance camera is detected is received.

10. The display control apparatus according to supplementary note 9, wherein

the display processing unit receives the signal from each of the plurality of surveillance cameras and displays the image of the surveillance camera from which the signal is received.

11. The display control apparatus according to any one of supplementary notes 1 to 10, wherein

the display processing unit displays the image of the surveillance camera by switching from an advertisement image.

12. The display control apparatus according to supplementary note 11, wherein

the display processing unit alternately displays the advertisement image and the image of the surveillance camera.

13. The display control apparatus according to any one of supplementary notes 1 to 12, wherein

the display processing unit displays together an advertisement image and the image of the surveillance camera.

14. A display control system including:

a surveillance camera of a store;

at least one display installed in the store; and

a display control apparatus, wherein

the display control apparatus includes

a display processing unit that displays, when a predetermined condition is satisfied, an image of the surveillance camera on the at least one display.

15. The display control system according to supplementary note 14, wherein

the at least one display further includes a display of a POS terminal.

16. The display control system according to supplementary note 14 or 15, wherein

the predetermined condition includes a case in which a signal for setting an operation pattern of the store as a determined mode is input.

17. The display control system according to any one of supplementary notes 14 to 16, wherein

the predetermined condition includes a case in which a predetermined time comes.

18. The display control system according to any one of supplementary notes 14 to 17, wherein

the predetermined condition includes a case in which an image processing result of a customer satisfies a criterion.

19. The display control system according to any one of supplementary notes 14 to 18, wherein

the display processing unit of the display control apparatus displays an advertisement image and the image of the surveillance camera with a ratio of both of the images changed according to a result of image recognition processing for a customer.

20. The display control system according to any one of supplementary notes 14 to 19, wherein

the predetermined condition includes a case in which input by at least either of a store clerk and a remote surveillant is accepted.

21. The display control system according to any one of supplementary notes 14 to 20, wherein

the predetermined condition includes a case in which an alarm is received.

22. The display control system according to any one of supplementary notes 14 to 21, wherein

the predetermined condition includes a case in which a signal indicating that a difference among a plurality of images respectively generated at different timings by the surveillance camera is detected is received.

23. The display control system according to supplementary note 22, wherein

the display processing unit of the display control apparatus receives the signal from each of the plurality of surveillance cameras and displays the image of the surveillance camera from which the signal is received.

24. The display control system according to any one of supplementary notes 14 to 23, wherein

the display processing unit of the display control apparatus displays the image of the surveillance camera by switching from an advertisement image.

25. The display control system according to supplementary note 24, wherein

the display processing unit of the display control apparatus alternately displays the advertisement image and the image of the surveillance camera.

26. The display control system according to any one of supplementary notes 14 to 25, wherein

the display processing unit of the display control apparatus screen-divides and displays together an advertisement image and the image of the surveillance camera on divided screens, respectively.

27. A display control method including,

by a display control apparatus,

displaying, when a predetermined condition is satisfied, an image of a surveillance camera of a store on at least one display installed in the store.

28. The display control method according to supplementary note 27, wherein

the at least one display further includes a display of a POS terminal.

29. The display control method according to supplementary note 27 or 28, wherein

the predetermined condition includes a case in which a signal for setting an operation pattern of the store as a determined mode is input.

30. The display control method according to any one of supplementary notes 27 to 29, wherein

the predetermined condition includes a case in which a predetermined time comes.

31. The display control method according to any one of supplementary notes 27 to 30, wherein

the predetermined condition includes a case in which an image processing result of a customer satisfies a criterion.

32. The display control method according to any one of supplementary notes 27 to 31, further including,

by the display control apparatus,

displaying an advertisement image and the image of the surveillance camera with a ratio of both of the images changed according to a result of image recognition processing for a customer.

33. The display control method according to any one of supplementary notes 27 to 32, wherein

the predetermined condition includes a case in which input by at least either of a store clerk and a remote surveillant is accepted.

34. The display control method according to any one of supplementary notes 27 to 33, wherein

the predetermined condition includes a case in which an alarm is received.

35. The display control method according to any one of supplementary notes 37 to 34, wherein

the predetermined condition includes a case in which a signal indicating that a difference among a plurality of images respectively generated at different timings by the surveillance camera is detected is received.

36. The display control method according to supplementary note 35, further including,

by the display processing apparatus,

receiving the signal from each of the plurality of surveillance cameras and displaying the image of the surveillance camera from which the signal is received.

37. The display control method according to supplementary notes 27 to 36, further including,

by the display processing apparatus,

displaying the image of the surveillance camera by switching from an advertisement image.

38. The display control method according to supplementary note 37, further including,

by the display processing apparatus,

alternately displaying the advertisement image and the image of the surveillance camera.

39. The display control method according to any one of supplementary notes 27 to 38, further including,

by the display processing apparatus,

screen-dividing and displaying together an advertisement image and the image of the surveillance camera.

40. A program for causing a computer to execute

a procedure of displaying, when a predetermined condition is satisfied, an image of a surveillance camera of a store on at least one display installed in the store.

41. The program according to supplementary note 40, wherein

the at least one display further includes a display of a POS terminal.

42. The program according to supplementary note 40 or 41, wherein

the predetermined condition includes a case in which a signal for setting an operation pattern of the store as a determined mode is input.

43. The program according to any one of supplementary notes 40 to 42, wherein

the predetermined condition includes a case in which a predetermined time comes.

44. The program according to any one of supplementary notes 40 to 43, wherein

the predetermined condition includes a case in which an image processing result of a customer satisfies a criterion.

45. The program according to any one of supplementary notes 40 to 44, for further causing a computer to execute

a procedure of displaying an advertisement image and the image of the surveillance camera with a ratio of both of the images changed according to a result of image recognition processing for a customer.

46. The program according to any one of supplementary notes 40 to 45, wherein

the predetermined condition includes a case in which input by at least either of a store clerk and a remote surveillant is accepted.

47. The program according to any one of supplementary notes 40 to 46, wherein

the predetermined condition includes a case in which an alarm is received.

48. The program according to any one of supplementary notes 40 to 47, wherein

the predetermined condition includes a case in which a signal indicating that a difference among a plurality of images respectively generated at different timings by the surveillance camera is detected is received.

49. The program according to supplementary note 48, for further causing a computer to execute

a procedure of receiving the signal from each of the plurality of surveillance cameras and displaying the image of the surveillance camera from which the signal is received.

50. The program according to any one of supplementary notes 40 to 49, for further causing a computer to execute

a procedure of displaying the image of the surveillance camera by switching from an advertisement image.

51. The program according to supplementary note 50, for further causing a computer to execute

a procedure of alternately displaying the advertisement image and the image of the surveillance camera.

52. The program according to any one of supplementary notes 40 to 51, for further causing a computer to execute

a procedure of screen-dividing and displaying together an advertisement image and the image of the surveillance camera.

This application is based upon and claims the benefit of priority from Japanese patent application No. 2019-151771, filed on Aug. 22, 2019, the disclosure of which is incorporated herein in its entirety by reference.

### REFERENCE SIGNS LIST

3 Communication network
5 Surveillance camera
7 Product shelf
10 Display
12 Signage
20 POS terminal
22 Display
24 Scanner
26 Printer
30 POS screen
32 First screen region
34 Second screen region
40 Screen
42 Advertisement image
44 Crime prevention video
100 Display control apparatus
102 Display processing unit
104 Difference detection unit
110 Content storage unit
120 Image processing unit
1000 Computer
1010 Bus
1020 Processor
1030 Memory
1040 Storage device
1050 Input/output interface
1060 Network interface
D1, D2, D3, D4 Display screen
A1, A2, A3, A4, A5, A6, A7, A8, A9 Camera
S1, S2, S3, S4, S5, S6, S7, S8, S9 Difference detection signal

What is claimed is:

1. A display control apparatus comprising
a display processing unit that displays, when a predetermined condition is satisfied, an image of a surveillance camera of a store on at least one display installed in the store.

2. The display control apparatus according to claim 1, wherein
the at least one display further includes a display of a POS terminal.

3. The display control apparatus according to claim 1, wherein
the predetermined condition includes a case in which a signal for setting an operation pattern of the store as a determined mode is input.

4. The display control apparatus according to claim 1, wherein
the predetermined condition includes a case in which a predetermined time comes.

5. The display control apparatus according to claim 1, wherein
the predetermined condition includes a case in which an image processing result of a customer satisfies a criterion.

6. The display control apparatus according to claim 1, wherein
the display processing unit displays an advertisement image and the image of the surveillance camera with a ratio of both of the images changed according to a result of image recognition processing for a customer.

7. The display control apparatus according to claim 1, wherein
the predetermined condition includes a case in which input by at least either of a store clerk and a remote surveillant is accepted.

8. The display control apparatus according to claim 1, wherein
the predetermined condition includes a case in which an alarm is received.

9. The display control apparatus according to claim 1, wherein
the predetermined condition includes a case in which a signal indicating that a difference among a plurality of images respectively generated at different timings by the surveillance camera is detected is received.

10. The display control apparatus according to claim 9, wherein
the display processing unit receives the signal from each of the plurality of surveillance cameras and displays the image of the surveillance camera from which the signal is received.

11. The display control apparatus according to claim 1, wherein
the display processing unit displays the image of the surveillance camera by switching from an advertisement image.

12. The display control apparatus according to claim 11, wherein
the display processing unit alternately displays the advertisement image and the image of the surveillance camera.

13. The display control apparatus according to claim 1, wherein
the display processing unit screen-divides and displays together an advertisement image and the image of the surveillance camera.

14.-26. (canceled)

27. A display control method comprising,
by a display control apparatus,
displaying, when a predetermined condition is satisfied, an image of a surveillance camera of a store on at least one display installed in the store.

28. The display control method according to claim 27, wherein
the at least one display further includes a display of a POS terminal.

29. The display control method according to claim 27, wherein
the predetermined condition includes a case in which a signal for setting an operation pattern of the store as a determined mode is input.

30. The display control method according to claim 27, wherein
the predetermined condition includes a case in which a predetermined time comes.

31. The display control method according to claim 27, wherein
the predetermined condition includes a case in which an image processing result of a customer satisfies a criterion.

32-39. (canceled)

40. A non-transitory computer-readable storage medium storing a program for causing a computer to execute
a procedure of displaying, when a predetermined condition is satisfied, an image of a surveillance camera of a store on at least one display installed in the store.

41. The non-transitory computer-readable storage medium storing the program according to claim 40, wherein
the at least one display further includes a display of a POS terminal.

42-52. (canceled)
